(19) United States
(12) Patent Application Publication
(10) Pub. No.: US 2008/0287101 A1
(43) Pub. Date: Nov. 20, 2008

(54) Method for Generating a Pseudo-Esn in Mobile Communication

(76) Inventors: Jong Hoe An, Seoul (KR); Young Jun Kim, Gyeonggi-do (KR); Chan Ho Kyung, Gyeonggi-do (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/815,543

(22) PCT Filed: Feb. 7, 2006
(86) PCT No.: PCT/KR06/00444

§ 371 Date: May 5, 2008

(30) Foreign Application Priority Data
Feb. 7, 2005 (KR) 10-2005-0011471

(51) Int. Cl. H04M 1/68

(52) U.S. Cl. 455/411

(57) ABSTRACT

In generating a pseudo terminal identifier (pseudo-ESN; pseudo-Electronic Serial Number), a pseudo terminal identifier generating method includes the steps of generating a first configuration code by hashing a mobile equipment identifier (MEID), selecting a second configuration code from codes not used as an electronic serial number (ESN), and generating the pseudo terminal identifier by setting MSB (most significant bit) to the first configuration code and by setting LSB (least significant bit) to the second configuration code. Accordingly, the present invention provides a pseudo terminal identifier after a related art ESN is exhausted.

### TECHNICAL FIELD

The present invention relates to pseudo terminal identifier generating method, and more particularly, to a method of generating a pseudo terminal identifier using MEID to prepare for exhaustion of ESN.

### BACKGROUND ART

FIG. 1 is a structural diagram of ESN. An electronic serial number (hereinafter abbreviated 'ESN) currently applied the cdma2000 system is constructed with a manufacturer's code (hereinafter abbreviated 'MFC) and a serial number.

The ESN, as shown in FIG. 1, has a 32-bit length and is constructed with an MFC configuring upper eight bits and a serial number configuring the rest of twenty-four bits. The MFC is a code allocated to each mobile communication terminal manufacturer, and the serial number is a unique number granted to each terminal by each manufacturer.

The ESN is a unique identifier for each terminal and is used for user authentication, public long code mask (hereinafter abbreviated 'PLCM) and the like in a mobile communication system and terminal.

FIG. 2 is a structural diagram of PLCM used for the cdma 2000 system.

Referring to FIG. 2, a PLCM is constructed with 42-bits. Upper bits of the 42-bits are set to a fixed value to avoid collision with another long code mask, and lower 32-bits are set to permutated-ESN or permuted ESN.

Meanwhile, 32-bit unique number named UIM_ID is allocated to R-UIM (removable user identity module) as well. The UIM_ID is allocated not to be overlapped with ESN within an area to which the ESN is allocated. Once R-UIM is attached to a terminal, a 1-bit indicator named UIM_ID Usage Indicator is set to ‘1’, and UIM_ID is used for all that uses ESN. Hence, in constructing PLCM in a terminal having R-UIM attached thereto, the lower 32-bits in FIG. 2 c an be constructed with permuted-UIM_ID (or permutated-UIM_ID) instead of permuted-ESN.

As the output of terminals increases, it is expected that 32-bit ESN will be exhausted sooner or later. So, in cdma2000 Revision D, mobile equipment identifier (hereinafter abbreviated 'MEID) is used as a new identifier to identify terminals.

FIG. 3 is a structural diagram of MEID. Referring to FIG. 3, MEID is constructed with 56-bits. MFC is allocated to MSB 32-bits and a terminal serial number (SN) of a corresponding manufacturer is allocated to LSB 24-bits. The ESN exhaustion problem can be solved by using the MEID if cdma200 Revision D is implemented in system and terminal.

However, in a current situation, it is expected that ESN will be exhausted before cdma2000 Revision D is implemented. So, a temporary solution for the ESN exhaustion problem is needed before cdma2000 Revision D is implemented. In case that ESN and UIM_ID are exhausted, collision occurs in PLCM generated using ESN or UIM_ID. If the collision occurs in PLCM, cross-talk takes place or subscriber accommodating capacity may be considerably reduced.

### DISCLOSURE OF INVENTION

In generating a pseudo terminal identifier (pseudo-ESN; pseudo-Electronic Serial Number), a pseudo terminal identifier generating method according to the present invention includes the steps of generating a first configuration code by hashing a mobile equipment identifier (MEID), selecting a second configuration code from codes not used as an electronic serial number (ESN), and generating the pseudo terminal identifier by setting MSB (most significant bit) to the first configuration code and by setting LSB (least significant bit) to the second configuration code.

Preferably, the mobile equipment identifier (MEID) has a 56-bit length and wherein the first configuration code generated from hashing has a 24-bit length. Meanwhile, the second configuration code is preferably set to ‘10000000’.

### BRIEF DESCRIPTION OF THE DRAWINGS

FIG. 1 is a structural diagram of ESN.

FIG. 2 is a structural diagram of PLCM used for the cdma 2000 system.

FIG. 3 is a structural diagram of MEID.

FIG. 4 is a diagram for a pseudo terminal identifier generation method according to one embodiment.

FIG. 5 is a diagram of PLCM using a pseudo terminal identifier according to one embodiment of the present invention.

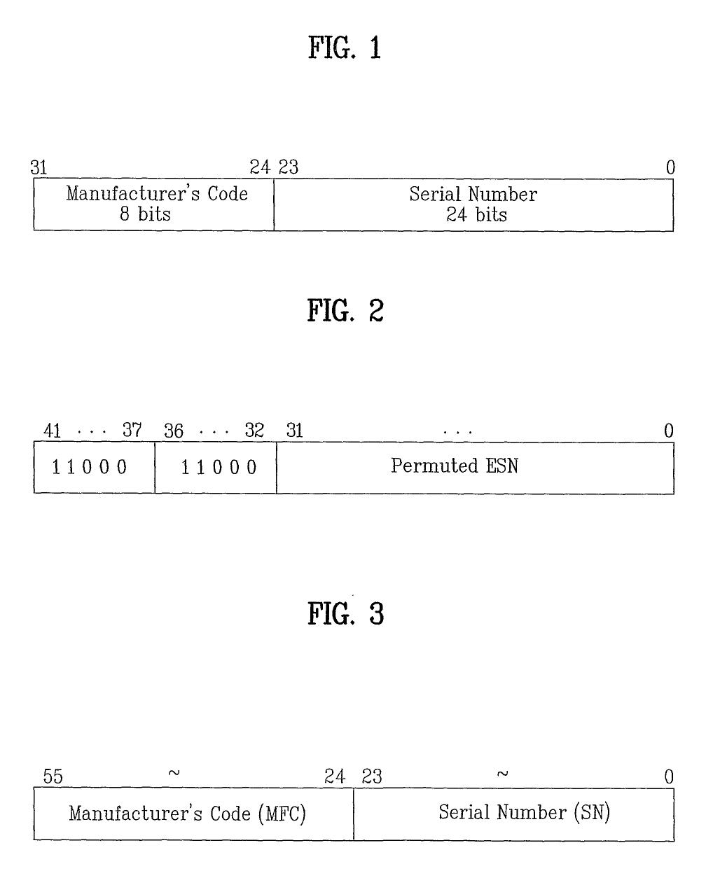

### MODE FOR CARRYING OUT THE INVENTION

The aforesaid objectives, features and advantages of the invention will be set forth in the description which follows, and in part will be apparent from the description. Reference will now be made in detail to one preferred embodiment of the present invention, examples of which are illustrated in the accompanying drawings.

The present invention provides a method of allocating MEID defined in cdma2000 Revision D to a terminal (IS-95, cdma2000 Revision O, cdma2000 Revision A, cdma2000 Revision B, cdma2000 Revision C terminal; hereinafter called ‘legacy terminal’) prior to cdma2000 Revision D.

Since a system prior to cdma2000 Revision D is unable to recognize MEID, a legacy terminal having MEID allocated thereto should not use MEIF in operating with the system. Hence, a 32-bit pseudo terminal identifier (pseudo-ESN) generated using MEID is allocated to a legacy terminal to which the MEID is allocated instead of allocating the MEID directly to the legacy terminal.

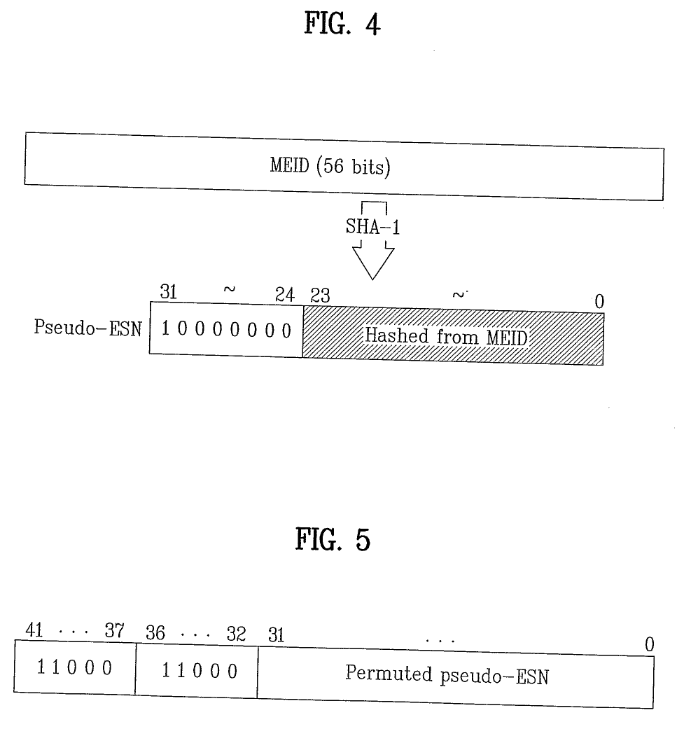

FIG. 4 is a diagram for a pseudo terminal identifier generation method according to one embodiment. Referring to FIG. 4, the pseudo terminal identifier is generated using MEID and SHA-1 algorithm. In particular, MSB 8-bits of pseudo terminal identifier are set to ‘10000000’ not used for conventional ESN, and LSB 24-bits can be generated by hashing 56-bit MEID into 24-bits using SHA-1 algorithm.

The pseudo terminal identifier allocated to a terminal is stored in an ESNp part as a permanent storeroom and can be used for such a conventional ESN usage as PLCM generation and the like.

FIG. 5 is a diagram of PLCM using a pseudo terminal identifier according to one embodiment of the present invention. Referring to FIG. 5, PLCM can be generated using a pseudo terminal identifier instead of using a related art ESN.

By storing a pseudo terminal identifier in an ESNp storeroom of a terminal using MEID, a terminal or a system substantially decides a corresponding pseudo terminal identifier identical to ESN to perform operations. Hence, it is unnecessary to perform additional alteration on a legacy terminal and system.

Moreover, MSB 8-bits (‘10000000’) of a pseudo terminal identifier is different from MBS 8-bits of the related art ESN, it is able to prevent collision between PLCM of a legacy terminal having ESN allocated thereto and PLCM of a legacy terminal having MEID allocated thereto. A proposal of the present invention is applicable to a legacy terminal (IS-95, cdma2000 Revision O, cdma2000 Revision A, cdma2000 Revision B, cdma2000 Revision C terminal) prior to implementation of Revision D after ESN is exhausted.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, the present invention is applicable to a mobile communication terminal.

1. In generating a pseudo terminal identifier (pseudo-ESN; pseudo-Electronic Serial Number), a pseudo terminal identifier generating method comprising the steps of:
generating a first configuration code by hashing a mobile equipment identifier (MEID);
selecting a second configuration code from codes not used as an electronic serial number (ESN); and
generating the pseudo terminal identifier by setting MSB (most significant bit) to the first configuration code and by setting LSB (least significant bit) to the second configuration code.

2. The method of claim 1, wherein the mobile equipment identifier (MEID) has a 56-bit length and wherein the first configuration code generated from hashing has a 24-bit length.

3. The method of claim 1, wherein the second configuration code is ‘10000000’.
